(19) United States
(12) Patent Application Publication
(10) Pub. No.: US 2019/0121968 A1
(43) Pub. Date: Apr. 25, 2019

(54) KEY GENERATION SOURCE IDENTIFICATION DEVICE, KEY GENERATION SOURCE IDENTIFICATION METHOD, AND COMPUTER READABLE MEDIUM

(71) Applicant: MITSUBISHI ELECTRIC CORPORATION, Tokyo (JP)

(72) Inventors: Hiroki NISHIKAWA, Tokyo (JP); Tomonori NEGI, Tokyo (JP); Kiyoto KAWAUCHI, Tokyo (JP)

(73) Assignee: MITSUBISHI ELECTRIC CORPORATION, Tokyo (JP)

(21) Appl. No.: 16/094,450

(22) PCT Filed: Jun. 16, 2016
(86) PCT No.: PCT/JP2016/067929

§ 371 Date: Oct. 17, 2018

(51) Int. Cl. G06F 21/55; G06F 21/56; H04L 9/08

(52) U.S. Cl. CPC G06F 21/552; G06F 21/562; G06F 2221/033; G06F 21/566; H04L 9/0861; G06F 21/567

(57) ABSTRACT

A key generation source identification device (10) is provided with a key identification unit (11) to cause malware to execute an encryption process, acquire an execution trace representing an execution status of the encryption process, and identify an encryption key used in the encryption process as an analysis key based on the execution trace, and an extraction unit (31) to extract, from the execution trace, a list of instructions on which the analysis key depends, as an instruction list. The key generation source identification device (10) is also provided with an acquisition unit (32) to determine whether a function called by a call instruction included in the instruction list is a dynamic acquisition function that acquires dynamic information dynamically changing and, when the function is the dynamic acquisition function, acquire the instruction list as a candidate of a key generation source which is at least a part of a program that generated the analysis key in the encryption process.

### TECHNICAL FIELD

The present invention relates to a key generation source identification device, a key generation source identification method, and a key generation source identification program.

### BACKGROUND ART

In recent years, targeted attacks to enterprises and government agencies aiming at theft of confidential information occur frequently, which is a serious security threat. Common targeted attacks begin with a mail with cleverly crafted text being transmitted to a target of attack. A document file containing malware is attached to this mail and a terminal is infected with the malware the moment a mail recipient opens this document at the terminal. An attacker controls this malware from a command server (C & C server: command and control server) on the Internet and looks for confidential information through a network inside a target organization to upload to the C & C server, thereby achieving the purpose. With the increasing severity of damage due to confidential information leakage, attention has been focused on a network forensics technology which reveals the behavior of malware in an infected terminal by analyzing logs generated by personal computers, servers, and the like infected with malware.

However, some of recent malware keep communication data secret by encrypting communication data by common key encryption. Since communication data of such malware is recorded in an encrypted state, the communication data cannot be analyzed as it is. Accordingly, a malware analyst needs to work for identifying an encryption algorithm used by malware to encrypt communication data and an encryption key used for encryption and for decrypting the encrypted communication. Since this work requires reverse engineering of malware, it takes a huge amount of effort and time in general. For such a reason, a technique of automatically identifying the encryption algorithm of malware and a technique of identifying the encryption key are studied.

Patent Literature 1 discloses a technology for identifying a key by holding an encryption function inside such that an execution trace of an instruction executed by malware is recorded and analyzed including data of arithmetic operations in order to identify an encryption key of the malware that encrypts information to upload.

Non Patent Literature 1 discloses a technology that prepares a template of a known encryption algorithm and, by giving the same input to this template and an algorithm to be evaluated, judges that the algorithm to be evaluated is the same as the algorithm of the template if the output is the same.

### CITATION LIST

### Patent Literature

Patent Literature 1: JP 2013-114637 A

### Non-Patent Literature

Non-Patent Literature 1: Joan Calvet, Jose M. Fernandez, Jean-Yves Marion, Aligot: Cryptographic Function Identification in Obfuscated Binary Programs, Proceedings of the 19th ACM Conference on Computer and Communications Security, CCS 2012.
Non-Patent Literature 2: Yuhei Kawakoya, Eitaro Shioji, Makoto Iwamura, Takeo Hariu, Tracing Malicious Code with Taint Propagation, Computer Security Symposium 2012

### SUMMARY OF INVENTION

### Technical Problem

According to the conventional technologies, an encryption algorithm used by malware can be certainly identified but, for malware that dynamically generates the key, there has been a problem that a key corresponding to a communication log to be decrypted cannot be identified. Dynamic key generation mentioned here is defined as creating and using a key on the basis of information and the like in the environment where malware is active, without hardcoding a key used for encryption in malware.

Malware that dynamically generates a key generates a key to be used for encryption, for example, using an Internet protocol (IP) address on an infected terminal as a seed with which an encryption key is to be generated and encrypts a confidential file to steal. In this case, different keys are generated in different terminals and are used for encryption. For this reason, a key of a terminal where the damage occurred (hereinafter referred to as a damage key) is different from a key in a malware analysis environment (hereinafter referred to as an analysis key). Here, since leakage information is produced in a damaged environment, the leakage information is encrypted by the damage key. Accordingly, the encrypted communication log cannot be decrypted with the analysis key available in the analysis environment.

As described above, in the conventional technologies, although the analysis key can be identified, there has been a problem that the damage key cannot be identified.

The present invention aims at identifying a key generation source which is information necessary for generating a damage key, in order to identify the damage key.

### Solution to Problem

A key generation source identification device according to the present invention includes:

a key identification unit to cause malware to execute an encryption process, acquire an execution trace representing an execution status of the encryption process, and identify an encryption key used in the encryption process as an analysis key based on the execution trace;

an extraction unit to extract, from the execution trace, a list of instructions on which the analysis key depends, as an instruction list; and

an acquisition unit to determine whether a function called by a call instruction included in the instruction list is a dynamic acquisition function that acquires dynamic information dynamically changing and, when the function called by the call instruction is the dynamic acquisition function, acquire the instruction list as a candidate of a key generation source which is at least a part of a program that generated the analysis key in the encryption process.

### Advantageous Effects of Invention

In the key generation source identification device according to the present invention, an extraction unit extracts an instruction list of instructions on which an encryption key depends, based on an execution trace of an encryption process by malware and the encryption key used in the encryption process. In addition, an acquisition unit determines whether a function called by a call instruction included in the instruction list is a dynamic acquisition function that acquires dynamic information dynamically changing. Then, when the function called by the call instruction is the dynamic acquisition function, the acquisition unit acquires the instruction list as a candidate of a key generation source which is at least a part of a program that generated the encryption key in the encryption process. Therefore, according to the key generation source identification device of the present invention, it is possible to obtain the key generation source of the encryption key used in the encryption process by malware and to reduce much effort to decrypt an encrypted file encrypted by malware.

### BRIEF DESCRIPTION OF DRAWINGS

FIG. 1 is a diagram illustrating an example in which malware dynamically generates a key.

FIG. 2 is a diagram illustrating how different keys are generated at respective terminals.

FIG. 3 is a diagram illustrating how a security operation center (SOC)/computer security incident response team (CSIRT) engineer requested to decrypt encrypted communication by malware cannot decrypt encrypted communication with an analysis key.

FIG. 4 is a configuration diagram of a key generation source identification device 10 according to a first embodiment.

FIG. 5 is a specific example of an execution trace 111 according to the first embodiment.

FIG. 6 is a flowchart illustrating a key generation source identification method 510 of the key generation source identification device 10 and a key generation source identification process S100 of a key generation source identification program 520 according to the first embodiment.

FIG. 7 is a flowchart illustrating a key generation source acquisition process S130 by a key generation source acquisition unit 130 according to the first embodiment.

FIG. 8 is a diagram illustrating how it is identified which memory on the execution trace 111 is an analysis key 121, on the basis of information from an analysis key identification unit 120.

FIG. 9 is a diagram illustrating how information having a dependency relationship with the analysis key 121 is found by taint analysis.

FIG. 10 is a diagram illustrating an instruction list 311 as a result of analysis by the taint analysis.

FIG. 11 is a diagram illustrating an example of a dynamic acquisition function 411 saved in a function database 141 according to the first embodiment.

FIG. 12 is a diagram illustrating an example of identifying an assemble list as a key generation source 321 from a plurality of assemble lists.

FIG. 13 is a configuration diagram of a key generation source identification device 10 according to a modification of the first embodiment.

FIG. 14 is a configuration diagram of a key generation source identification device 10a according to a second embodiment.

FIG. 15 is a diagram for explaining erroneous propagation of a taint, which is the reason why narrowing-down of key generation source candidates 322 is necessary.

FIG. 16 is a flowchart illustrating a key generation source identification process S100a of the key generation source identification device 10a according to the second embodiment.

FIG. 17 is a diagram exemplifying measurement of Levenshtein distance in the second embodiment.

FIG. 18 is a configuration diagram of a key generation source identification device 10b according to a third embodiment.

FIG. 19 is a flowchart illustrating a key generation source identification process S100b of the key generation source identification device 10b according to the third embodiment.

FIG. 20 is a diagram illustrating how a key generation program 151 according to the third embodiment is generated.

FIG. 21 is a configuration diagram of a key generation source identification device 10c according to a fourth embodiment.

FIG. 22 is a flowchart illustrating a key generation source identification process S100c of the key generation source identification device 10c according to the fourth embodiment.

### DESCRIPTION OF EMBODIMENTS

Hereinafter, embodiments of the present invention will be described with reference to the drawings. Note that, in the respective drawings, the same or equivalent parts are denoted by the same reference numerals. In the description of the embodiments, the explanation of the same or equivalent parts will be omitted or simplified as appropriate.

### First Embodiment

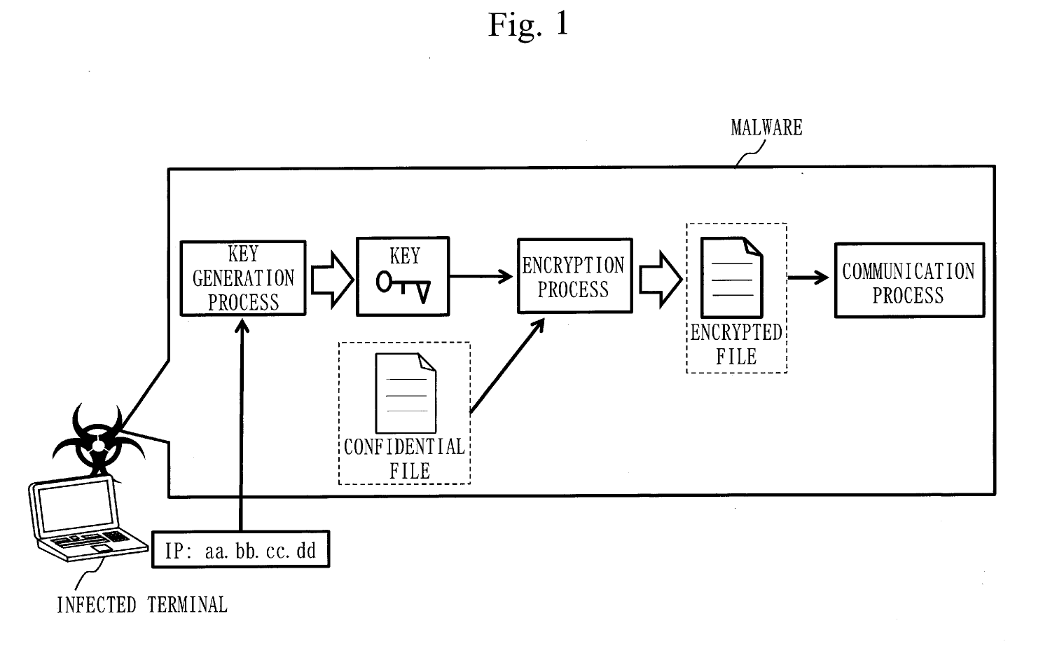

First, dynamic key generation will be described with reference to FIGS. 1 to 3.

FIG. 1 is a diagram illustrating an example in which malware dynamically generates a key.

Malware illustrated in this example generates a key to be used for encryption using an IP address on an infected terminal as a seed with which an encryption key is to be generated and encrypts a confidential file to steal. In this case, different keys are generated in different terminals and are used for an encryption process.

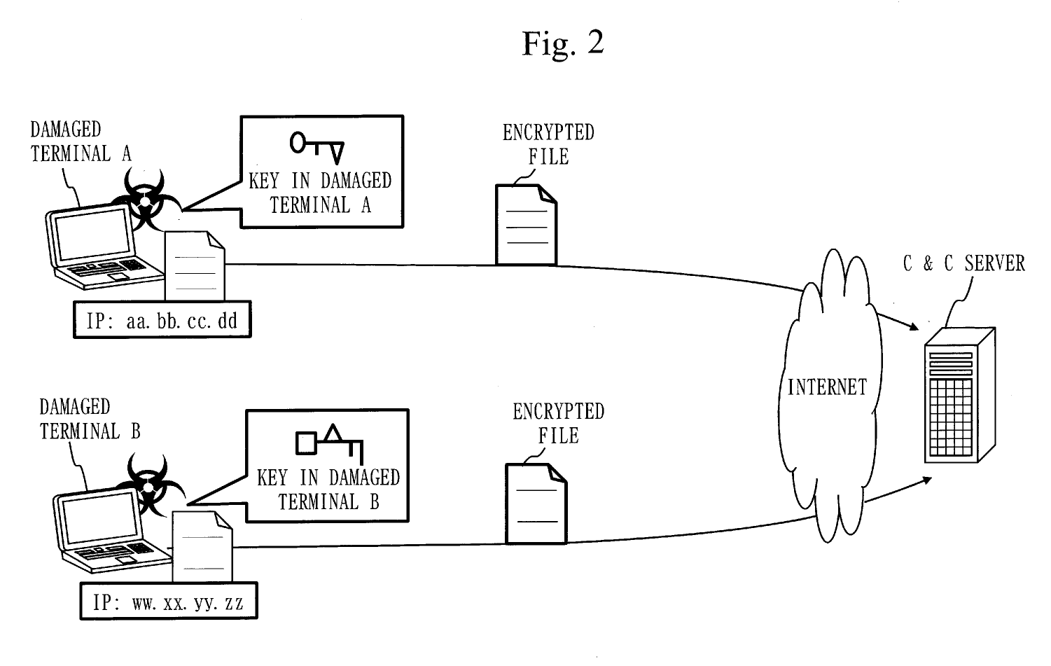

FIG. 2 is a diagram illustrating how different keys are generated at respective damaged terminals. Damaged terminals A and B are infected with the same malware, but keys used in the encryption process by malware are different.

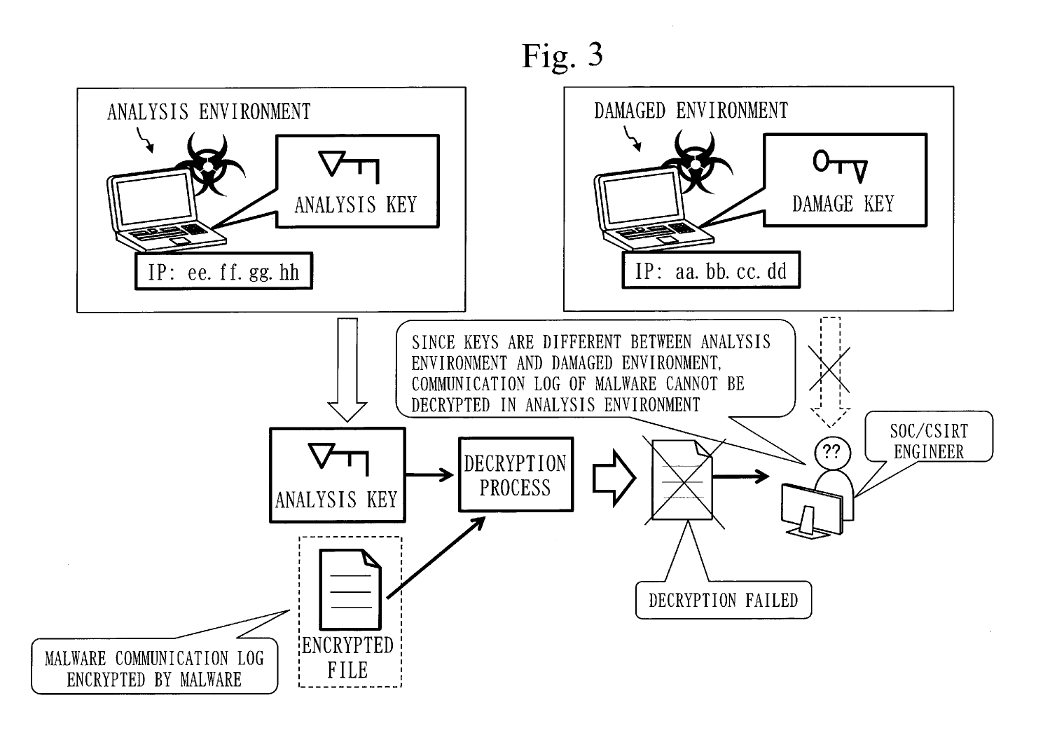

FIG. 3 illustrates how a security operation center (SOC)/computer security incident response team (CSIRT) engineer requested to decrypt an encrypted file encrypted by malware cannot decrypt the encrypted file with an analysis key. As illustrated in FIG. 3, when malware is analyzed, a damage key in a damaged environment where the damage occurred is different from an analysis key in a malware analysis environment. Since leakage information is produced in the damaged environment, the leakage information is encrypted by the damage key. For this reason, a confidential file such as an encrypted communication log cannot be decrypted with the analysis key available in the analysis environment.

In order to decrypt an encrypted file encrypted by malware, it is necessary to identify an encryption algorithm and an encryption key used by malware. However, when malware generates a key using environmental information on a terminal infected therewith, it is impossible to decrypt an encrypted file produced in the damaged environment with a key obtained in the analysis environment. Thus, the present embodiment will describe a key generation source identification device 10 capable of identifying which piece of the environmental information is used as a key generation source, on the basis of key information that can be identified in the analysis environment, and reducing effort involved in decrypting encrypted communication.

***Explanation of Configuration***

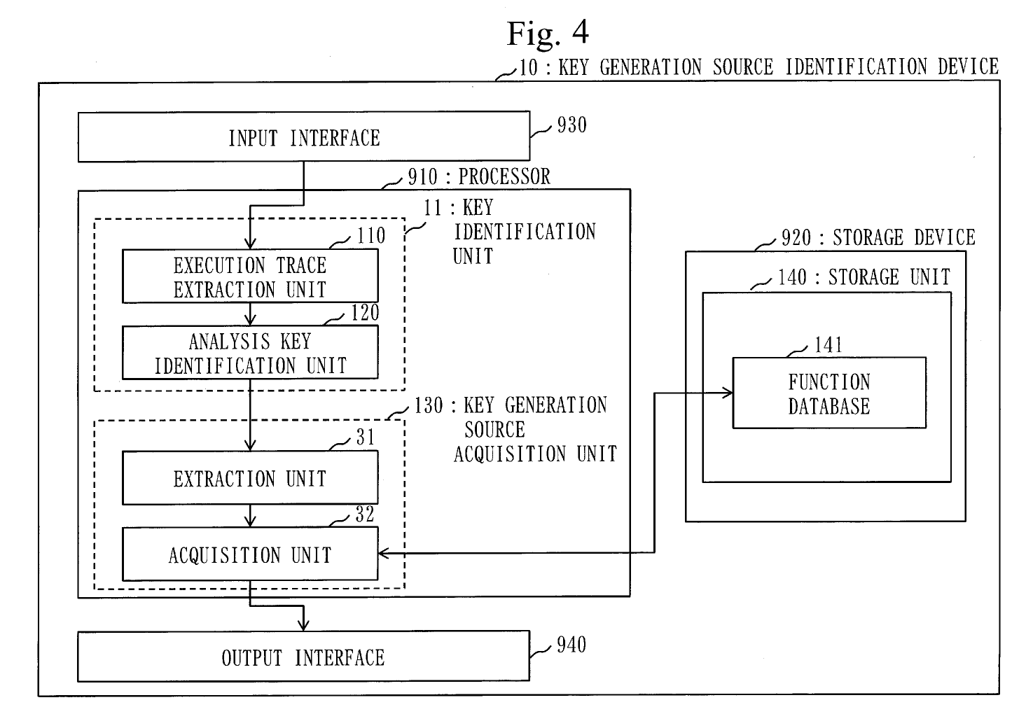

The configuration of the key generation source identification device 10 according to the present embodiment will be described with reference to FIG. 4.

In the present embodiment, the key generation source identification device 10 is a computer. The key generation source identification device 10 is provided with a processor 910 and also provided with other hardware such as a storage device 920, an input interface 930, and an output interface 940. The storage device 920 has a memory and an auxiliary storage device.

As illustrated in FIG. 1, the key generation source identification device 10 is provided with a key identification unit 11, a key generation source acquisition unit 130, and a storage unit 140 as a functional configuration. The key identification unit 11 is provided with an execution trace extraction unit 110 and an analysis key identification unit 120. The key generation source acquisition unit 130 is provided with an extraction unit 31 and an acquisition unit 32. A function database 141 is stored in the storage unit 140.

In the following description, the functions of the key identification unit 11 (the execution trace extraction unit 110 and the analysis key identification unit 120) and the key generation source acquisition unit 130 (the extraction unit 31 and the acquisition unit 32) of the key generation source identification device 10 are referred to as the functions of the “units” of the key generation source identification device 10.

The functions of the “units” of the key generation source identification device 10 are implemented by software.

In addition, the storage unit 140 is implemented by the storage device 920.

The processor 910 is connected to other pieces of hardware via signal lines and controls these other pieces of hardware.

The processor 910 is an integrated circuit (IC) that performs processing. Specifically, the processor 910 is a central processing unit (CPU) or the like.

The input interface 930 is a port connected to input devices such as a mouse, a keyboard, and a touch panel. Specifically, the input interface 930 is a universal serial bus (USB) terminal. Note that the input interface 930 may be a port connected to a local area network (LAN).

The output interface 940 is a port to which a cable of a display device such as a display is connected. The output interface 940 is, for example, a USB terminal or a high definition multimedia interface (HDMI) (registered trademark) terminal. Specifically, the display is a liquid crystal display (LCD).

Specifically, the auxiliary storage device is a read only memory (ROM), a flash memory, or a hard disk drive (HDD). Specifically, the memory is a random access memory (RAM). The storage unit 140 may be implemented by the auxiliary storage device, may be implemented by the memory, or may be implemented by the memory and the auxiliary storage device. The method of implementing the storage unit 140 is arbitrary.

A program that implements the functions of the “units” is stored in the auxiliary storage device. This program is loaded to the memory to be read by the processor 910 and then executed by the processor 910. An operating system (OS) is also stored in the auxiliary storage device. At least a part of the OS is loaded to the memory and, while executing the OS, the processor 910 executes the program that implements the functions of the “units”.

The key generation source identification device 10 may be provided with a plurality of processors replacing the processor 910. This plurality of processors shares the execution of the program that implements the functions of the “units”. Like the processor 910, each processor is an IC that performs processing.

Information, data, signal values, and variable values indicating the results of processes by the functions of the “units” are stored in the memory, the auxiliary storage device, or a register or a cache memory in the processor 910. Note that, in FIG. 4, an arrow joining the respective units and the storage unit represents that the respective units store a result of a process in the storage unit, or that the respective units read information from the storage unit. In addition, arrows joining the respective units to each other represent the flow of control.

The program that implements the functions of the “units” of the key generation source identification device 10 may be stored in a portable recording medium such as a magnetic disk, a flexible disk, an optical disc, a compact disc, a Blu-ray (registered trademark) disc, and a digital versatile disc (DVD).

Note that the program that implements the functions of the “units” of the key generation source identification device 10 is also referred to as a key generation source identification program 520. In addition, what is called a key generation source identification program product is a storage medium and a storage device in which the key generation source identification program 520 is recorded and, regardless of an appearance format, a computer readable program is loaded.

***Explanation of Functional Configuration***

The execution trace extraction unit 110 causes malware to actually operate and acquires the execution trace 111 which is an operation record at that time. At this time, the execution trace 111 obtained by executing the encryption process is acquired by causing the malware to execute the encryption process. To acquire the execution trace 111, for example, technologies such as Intel's Pin and QEMU are used.

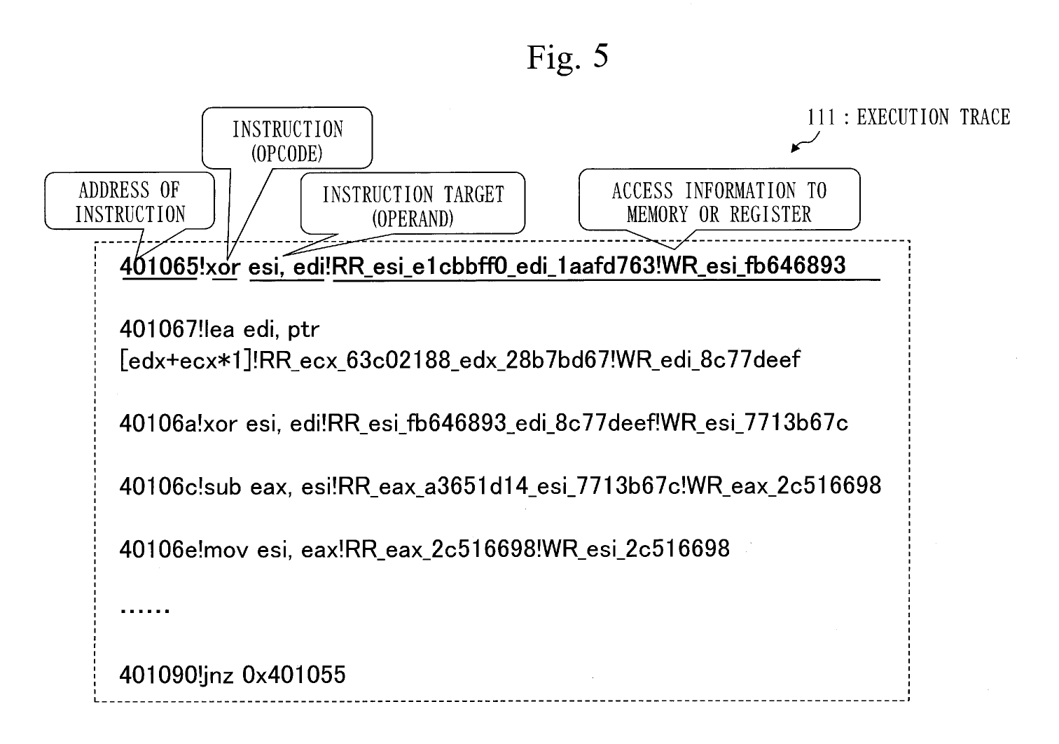

FIG. 5 is a specific example of the execution trace 111 according to the present embodiment.

The execution trace 111 is an operation record of a program. In practice, the execution trace 111 is constituted by information on an instruction executed when the program was executed, such as the address, instruction (opcode), instruction target (operand), access information to the memory or register, and name of the function that was called.

The analysis key identification unit 120 analyzes the execution trace 111 obtained from the execution trace extraction unit 110 and identifies the encryption key used in the encryption process. At this time, since the key identified by the analysis key identification unit 120 is an encryption key in the analysis environment, the identified encryption key is the analysis key 121.

The key generation source acquisition unit 130 tracks back an instruction having a dependency relationship with the analysis key 121 on instructions on the execution trace 111 using the analysis key 121 identified by the analysis key identification unit 120 as a starting point. The key generation source acquisition unit 130 tracks back all the instructions recorded in the execution trace 111 to obtain an instruction string, that is, an instruction list 311. When the call instruction included in the obtained instruction list 311 is a call instruction that calls a function included in the function database 141, the key generation source acquisition unit 130 acquires the instruction list 311 including this call instruction, as a key generation source 321 or as a key generation source candidate 322.

***Explanation of Operation***

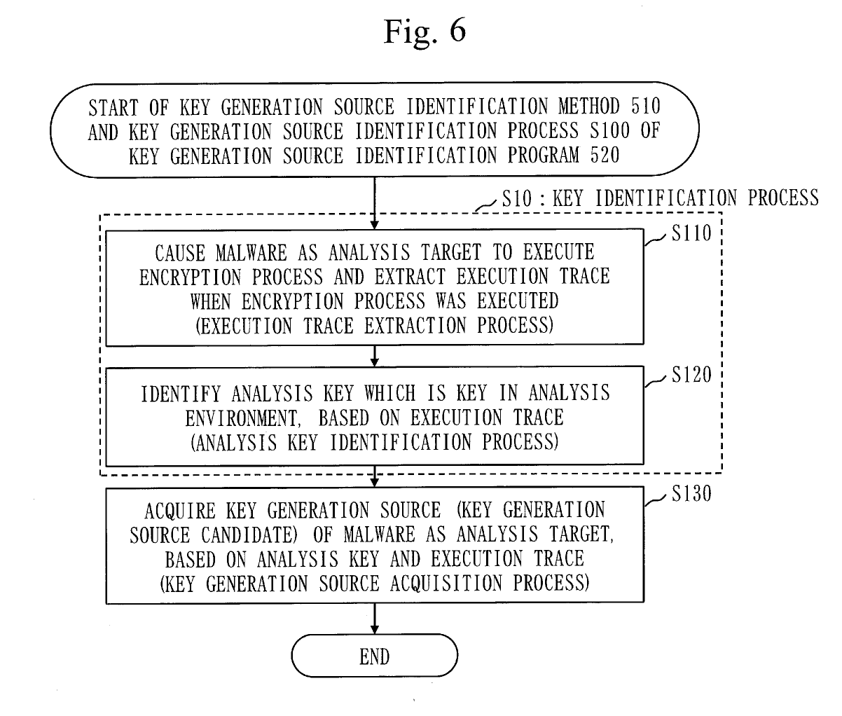

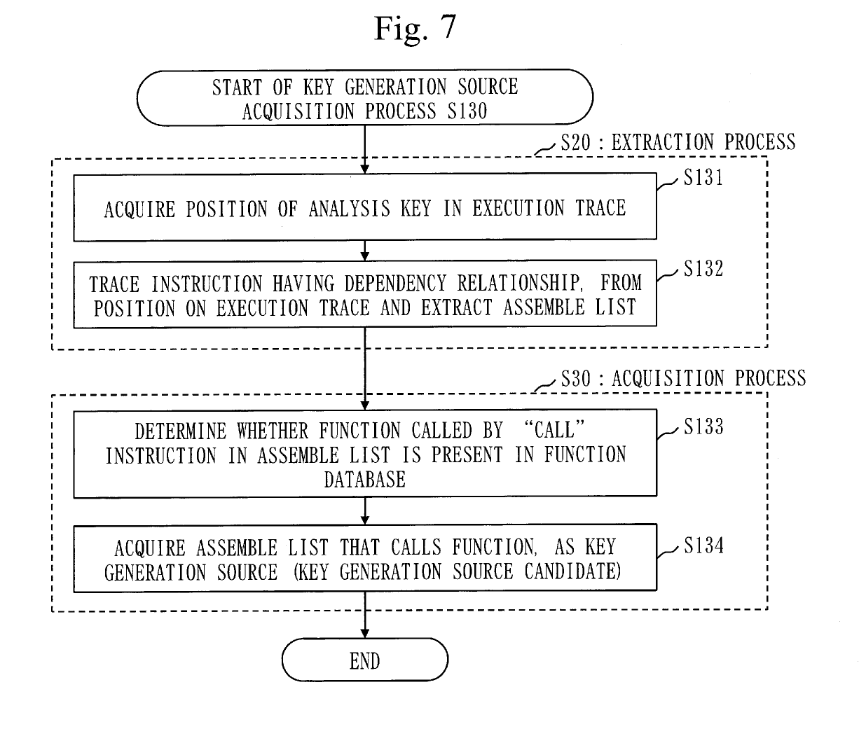

A key generation source identification method 510 of the key generation source identification device 10 and a key generation source identification process S100 of the key generation source identification program 520 according to the present embodiment will be described with reference to FIG. 6. In addition, a key generation source acquisition process S130 by the key generation source acquisition unit 130 according to the present embodiment will be described with reference to FIG. 7.

As illustrated in FIGS. 6 and 7, the key generation source identification process S100 has a key identification process S10 (an execution trace extraction process S110 and an analysis key identification process S120) and a key generation source acquisition process S130 (an extraction process S20 and an acquisition process S30).

<Key Identification Process S10>

In the key identification process S10, the key identification unit 11 executes the execution trace extraction process S110 that causes the malware to execute the encryption process and acquires the execution trace 111 representing the execution status of the encryption process. At this point, the key identification unit 11 executes the encryption process in the analysis environment. The key identification unit 11 also executes the analysis key identification process S120 that identifies the encryption key used in the encryption process executed in the analysis environment as the analysis key 121, based on the execution trace 111.

The key identification process S10 will be described in more detail.

In the execution trace extraction process S110, the execution trace extraction unit 110 acquires malware as an analysis target to cause the malware to execute the encryption process and acquires the execution trace 111. Specifically, malware as an analysis target is input to the execution trace extraction unit 110 by a user via the input interface 930. The execution trace extraction unit 110 obtains the execution trace 111 by causing the input malware to execute the encryption process.

In the analysis key identification process S120, the analysis key identification unit 120 acquires the execution trace 111 obtained by the execution trace extraction unit 110. The analysis key identification unit 120 acquires the analysis key 121 by analyzing the execution trace 111.

<Key Generation Source Acquisition Process S130>

In the key generation source acquisition process S130, the extraction unit 31 of the key generation source acquisition unit 130 executes the extraction process S10 that extracts, from the execution trace 111, a list of instructions on which the analysis key 121 depends, as the instruction list 311. In addition, the acquisition unit 32 of the key generation source acquisition unit 130 determines whether a function called by a call instruction included in the instruction list 311 is a dynamic acquisition function 411 that acquires dynamic information dynamically changing. When the function called by the call instruction is the dynamic acquisition function 411, the acquisition unit 32 executes the acquisition process S20 that acquires the instruction list 311 as a candidate of the key generation source 321 which is at least a part of a program that generated the analysis key 121 in the encryption process. Hereinafter, the candidate of the key generation source 321 will be described as the key generation source candidate 322.

The key generation source acquisition process S130 will be described in more detail.

In step S131, the extraction unit 31 acquires the position of the analysis key 121 in the execution trace 111. Specifically, the extraction unit 31 receives information on where the analysis key 121 is located on the execution trace 111, as information on the analysis key 121 identified by the analysis key identification unit 120.

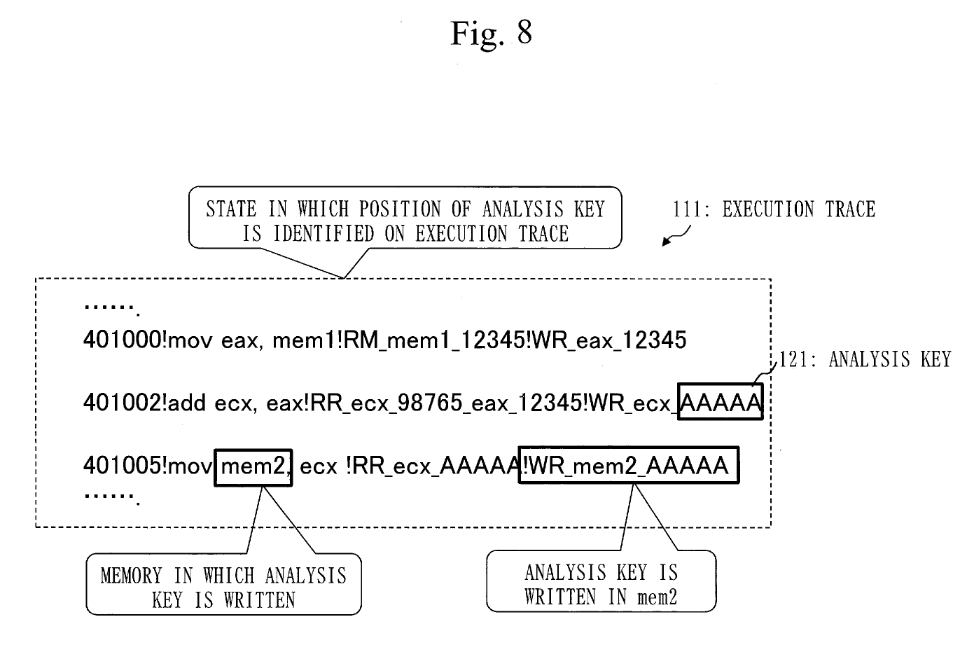

FIG. 8 illustrates how it is identified which memory on the execution trace 111 is the analysis key 121, on the basis of the information from the analysis key identification unit 120. In this example, a case where the analysis key 121 is “AAAAA” in hexadecimal notation and saved in mem2 is considered. Here, mem1 and mem2 refer to memory areas.

Meanwhile, the instruction on which the analysis key 121 depends is an instruction having a dependency relationship with the analysis key 121. In addition, the instruction list 311 of the instructions on which the analysis key 121 depends is a series of instruction strings obtained by tracking back an instruction having a dependency relationship with the analysis key 121.

In step S132, the extraction unit 31 traces an instruction on which the analysis key 121 depends, that is, an instruction having a dependency relationship with the analysis key 121, from the position mem2 of the identified analysis key 121. Specifically, the extraction unit 31 uses a taint analysis technique to trace an instruction having a dependency relationship with the analysis key 121 from the position mem2 of the analysis key 121. The taint analysis is dealt with by using a technique such as that of Non Patent Literature 2.

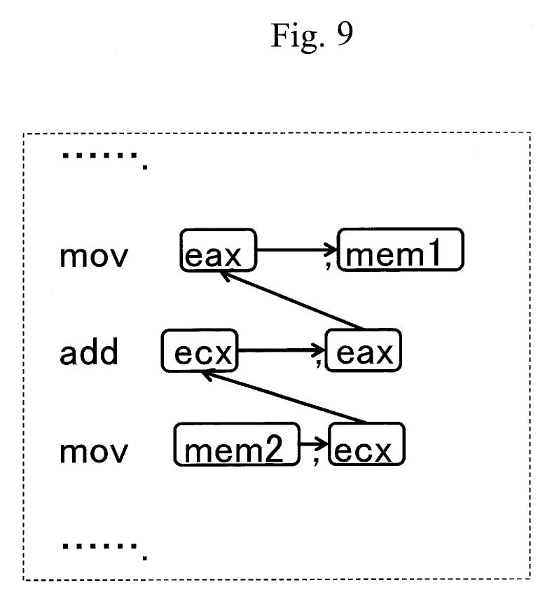

FIG. 9 illustrates how information having a dependency relationship with the analysis key is found by the taint analysis.

First, since mem2 saves therein the value of ecx, mem2 depends on the value of ecx. Next, ecx saves therein the result of adding the value of eax to ecx at the preceding stage. Furthermore, eax saves therein the value of mem1 at the further preceding stage. By going through dependency relationships in this manner, it can be seen that the value of mem2 eventually depends on the value of mem1.

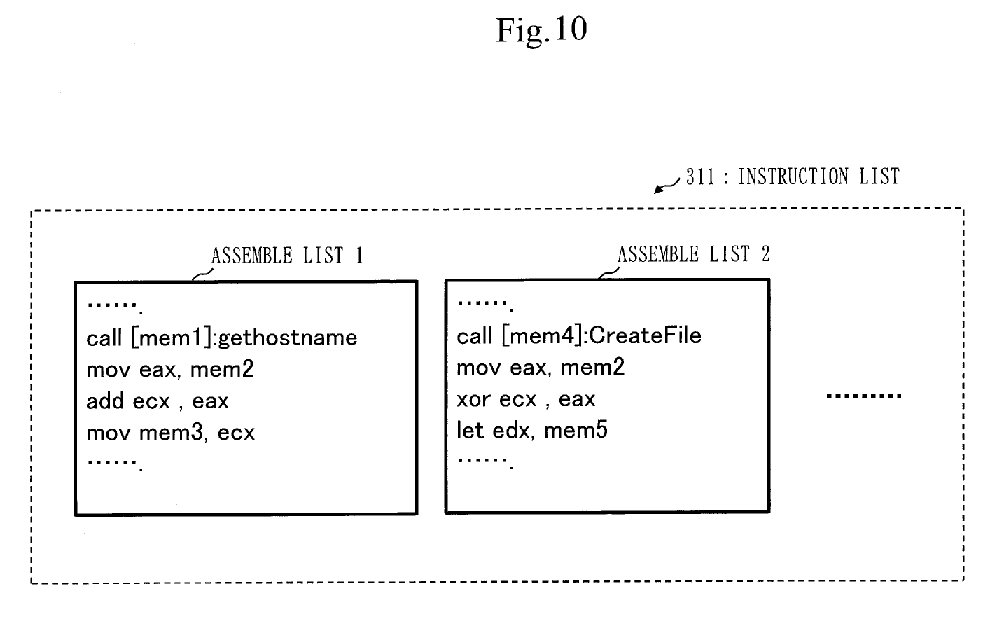

FIG. 10 is a diagram illustrating the instruction list 311 as a result of analysis by the taint analysis. The instruction list 311 is an assemble list.

The assemble list in FIG. 10 is a result of analysis over the entire execution trace 111 by the taint analysis. As illustrated in FIG. 10, a plurality of assemble lists is acquired in some cases.

Next, in step S133, the acquisition unit 32 determines whether the function called by a “call” instruction as the call instruction is included in the function database 141. Specifically, the acquisition unit 32 extracts a line of the call instruction, that is, the “call” instruction, from the instruction list 311, that is, the assemble list, and inquires whether the function database 141 has the same function as the function called by the “call” instruction.

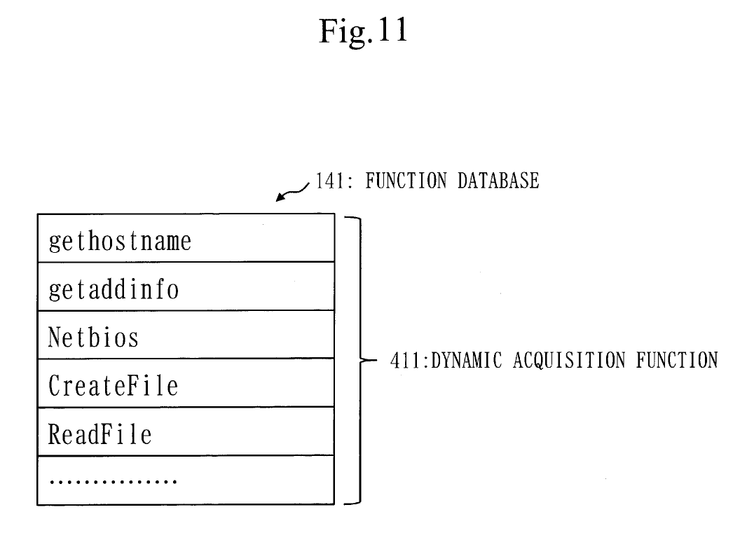

FIG. 11 is a diagram illustrating an example of the dynamic acquisition function 411 saved in the function database 141. The function database 141 saves therein the dynamic acquisition function 411.

The dynamic acquisition function 411 is a function that acquires information dynamically changing in accordance with the execution environment of the encryption process, as dynamic information (external information).

The function database 141 is configured by registering an application programming interface (API) for acquiring the external information, such as a communication API like Winsocket or an API for reading a file, as the dynamic acquisition function 411. The function database 141 is also referred to as an external information reference function database.

The external information is also referred to as dynamic information and refers to information other than hardcoded information such as a table in a program, which refers to information that changes from environment to environment, such as IP address, media access control (MAC) address, and time.

Next, in step S134, when the function called by the “call” instruction is included in the function database 141, the acquisition unit 32 acquires the assemble list serving as the instruction list, as the key generation source candidate 322. In other words, when the inquired function is included in the function database 141, the acquisition unit 32 acquires the assemble list calling the inquired function, as the key generation source candidate 322. Note that, in the present embodiment, the acquisition unit 32 specifies the key generation source candidate 322 as the key generation source 321.

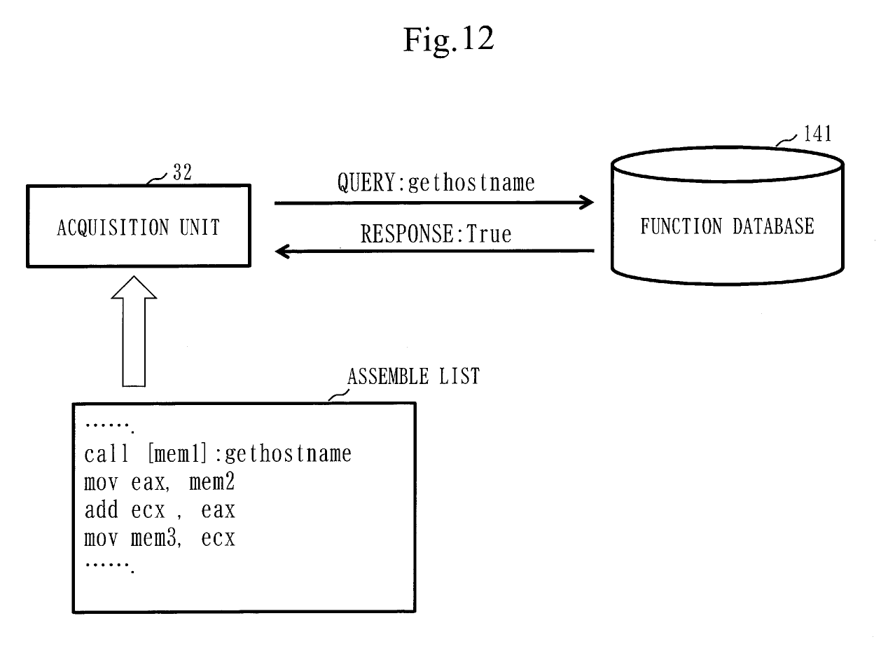

FIG. 12 is a diagram illustrating an example of identifying an assemble list as the key generation source 321 from a plurality of assemble lists.

First, the acquisition unit 32 fetches an assemble list as a determination target to be determined from a plurality of assemble lists. Next, the key generation source acquisition unit 130 extracts a function called by the “call” instruction from the fetched assemble list. In this case, gethostname is the called function. Next, the acquisition unit 32 transmits a query for gethostname to the function database 141 in order to confirm whether gethostname exists in the function database 141. In the function database 141, it is searched whether this query exists therein. In the example of the function database 141 in FIG. 11, since gethostname exists therein, True is returned as a response. Here, when a query that does not exist in the function database 141 is transmitted, False is returned as a response. Upon receiving True, the acquisition unit 32 determines that the assemble list as a determination target is the key generation source candidate 322. Then, the acquisition unit 32 specifies the assemble list determined to be the key generation source candidate 322 as the key generation source 321.

***Other Configuration***

The key generation source identification device 10 may have a communication interface that communicates with another network. The communication interface is provided with a receiver and a transmitter. Specifically, the communication interface is a communication chip or a network interface card (NIC). The communication interface functions as a communication unit that communicates data. The receiver functions as a reception unit that receives data and the transmitter functions as a transmission unit that transmits data.

In addition, in the present embodiment, the function of the key generation source identification device 10 is implemented by software, but as a modification, the function of the key generation source identification device 10 may be implemented by hardware.

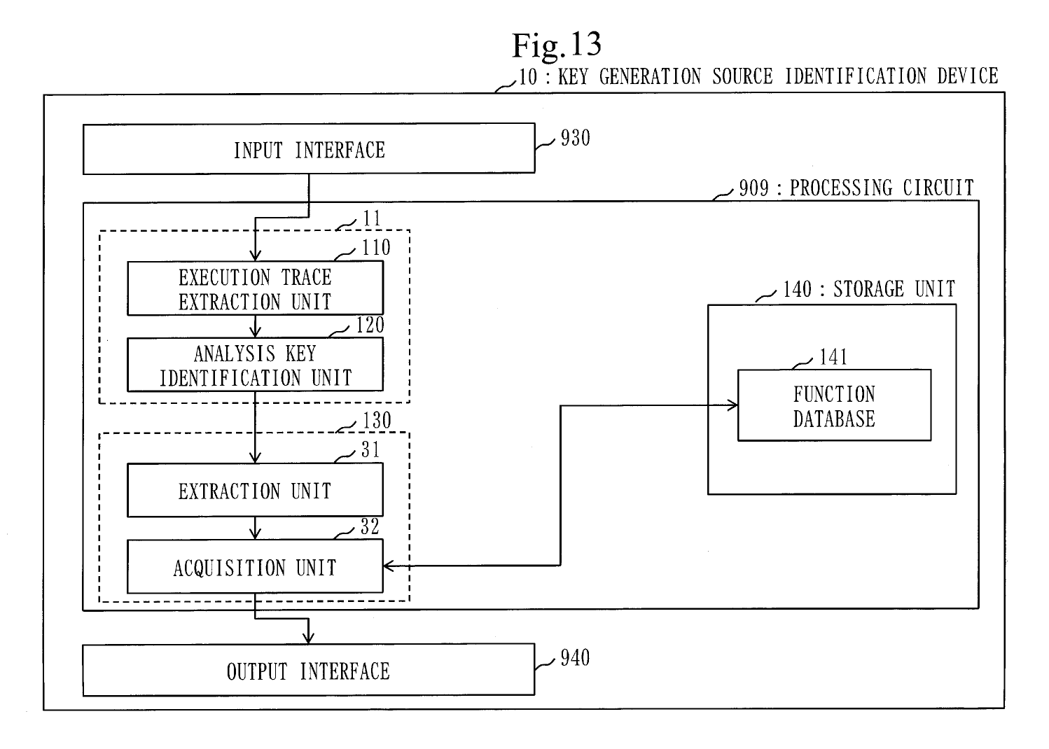

FIG. 13 is a diagram illustrating the configuration of a key generation source identification device 10 according to a modification of the present embodiment.

As illustrated in FIG. 13, the key generation source identification device 10 is provided with hardware such as a processing circuit 909, an input interface 930, and an output interface 940.

The processing circuit 909 is a dedicated electronic circuit that implements the above-mentioned functions of the “units” and the storage unit. Specifically, the processing circuit 909 is a single circuit, a composite circuit, a programmed processor, a parallel programmed processor, a logic IC, a gate array (GA), an application specific integrated circuit (ASIC), or a field-programmable gate array (FPGA).

The key generation source identification device 10 may be provided with a plurality of processing circuits replacing the processing circuit 909. The functions of the “units” are implemented as a whole by this plurality of processing circuits. Like the processing circuit 909, each processing circuit is a dedicated electronic circuit.

As another modification, the function of the key generation source identification device 10 may be implemented by a combination of software and hardware. That is, some functions of the key generation source identification device 10 may be implemented by dedicated hardware and the remaining functions thereof may be implemented by software.

The processor 910, the storage device 920, and the processing circuit 909 are collectively referred to as “processing circuitry”. In other words, whichever one of the configurations illustrated in FIGS. 1 and 7 the key generation source identification device 10 has, the functions of the “units” and the storage unit are implemented by the processing circuitry.

The “units” may be read as “phases”, “procedures”, or “processes”. In addition, the functions of the “units” may be implemented by firmware.

### Explanation of Effects of Present Embodiment

As described thus far, the key generation source identification device 10 according to the present embodiment can automatically obtain the key generation source which is important information for identifying the damage key from malware. Therefore, the key generation source identification device 10 according to the present embodiment can reduce much effort to decrypt encrypted communication by malware.

### Second Embodiment

In the present embodiment, a difference from the first embodiment will be mainly described.

In the present embodiment, the same reference numerals are given to configurations similar to those described in the first embodiment and the description thereof will be omitted.

***Explanation of Configuration***

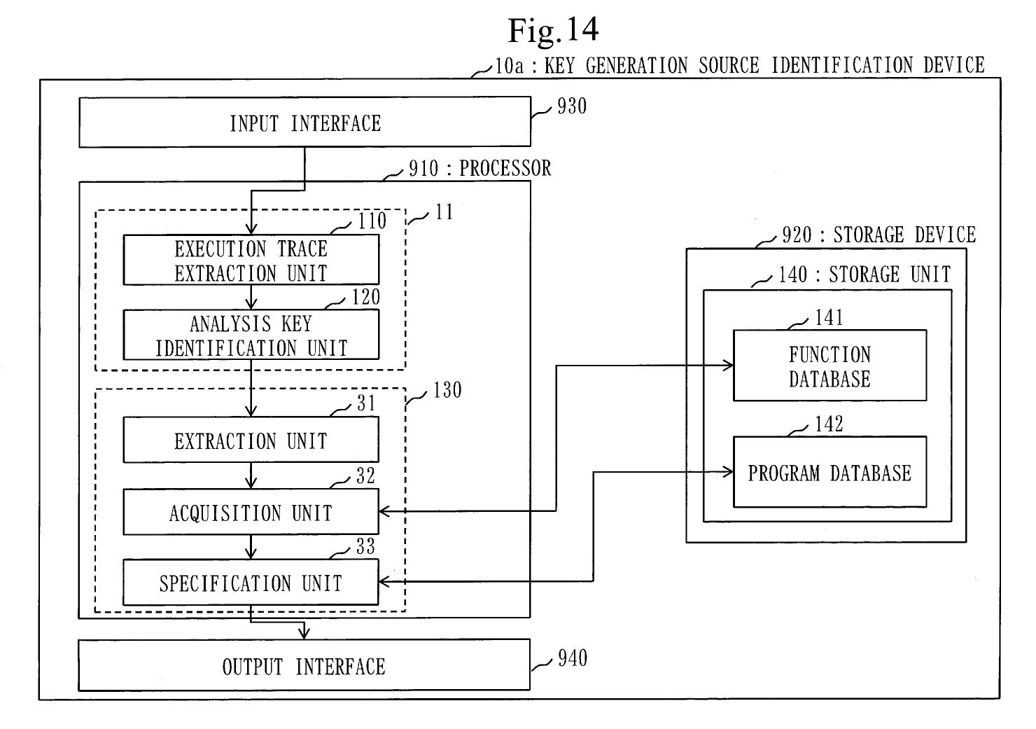

The configuration of a key generation source identification device 10a according to the present embodiment will be described with reference to FIG. 14.

In addition to the configuration of the first embodiment, the key generation source identification device 10a is further provided with a specification unit 33 in a key generation source acquisition unit 130. Additionally, the key generation source identification device 10a is further provided with a program database 142 in a storage unit 140. The other functional configuration and hardware configuration are the same as those in the first embodiment. Therefore, in the functional configuration of the key generation source identification device 10a, the specification unit 33 and the program database 142 are added to the functional configuration of the key generation source identification device 10. Furthermore, in the functions of the “units” of the key generation source identification device 10a, the function of the specification unit 33 is added to the functions of the “units” of the key generation source identification device 10.

Note that the present embodiment assumes that a key generation source candidate 322 is received from an acquisition unit 32.

The program database 142 saves therein a template of a program. The program database 142 saves therein a key generation program template in advance, which is a template of a key generation program having a possibility of being used in the encryption process by malware.

The specification unit 33 calculates the degree of similarity 412 between the key generation source candidate 322 and the key generation program template and determines whether the key generation source candidate 322 is similar to the key generation program template, based on this degree of similarity 412. When the key generation source candidate 322 is similar to the key generation program template, the specification unit 33 specifies the key generation source candidate 322 as a key generation source 321. In different terms, the specification unit 33 specifies the key generation source 321 from the key generation source candidates 322 acquired by the acquisition unit 32. The specification unit 33 narrows down which key generation source candidate 322 among the key generation source candidates 322 is actually the key generation source 321.

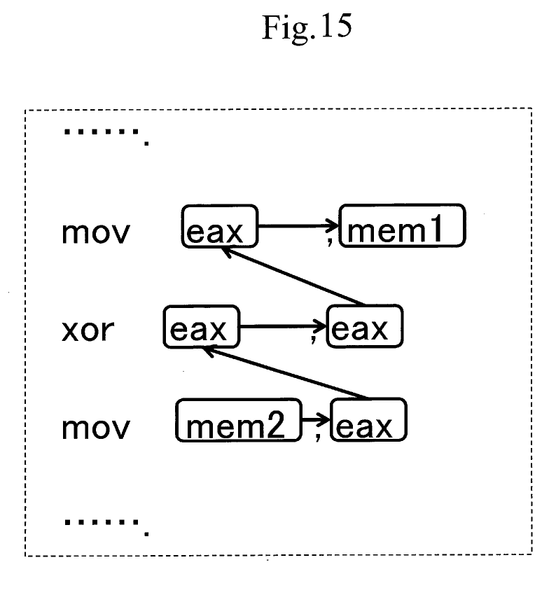

Erroneous propagation of a taint, which is the reason why narrowing-down of the key generation source candidates 322 is necessary, will be described with reference to FIG. 15.

Erroneous propagation of a taint means that a taint propagates erroneously to data originally having no dependency relationship and not to be traced. FIG. 15 illustrates a case where a taint propagates erroneously.

When the taint analysis is performed in the assemble list in FIG. 15, the result that mem2 depends on mem1 is obtained as in FIG. 9. However, “xor eax, eax” is a process of assigning zero to eax irrespective of the value of eax. Accordingly, in reality there is no dependency relationship between mem1 and mem2. In this manner, it is called erroneous propagation of a taint that data is tainted as if there is a dependency relationship in spite of actually having no dependency relationship.

Given that the erroneous propagation of a taint happens, in order to accurately identify the key generation source 321, it is necessary to narrow down the key generation source candidates 322 including an erroneous result due to erroneous propagation to the correct key generation source 321.

***Explanation of Operation***

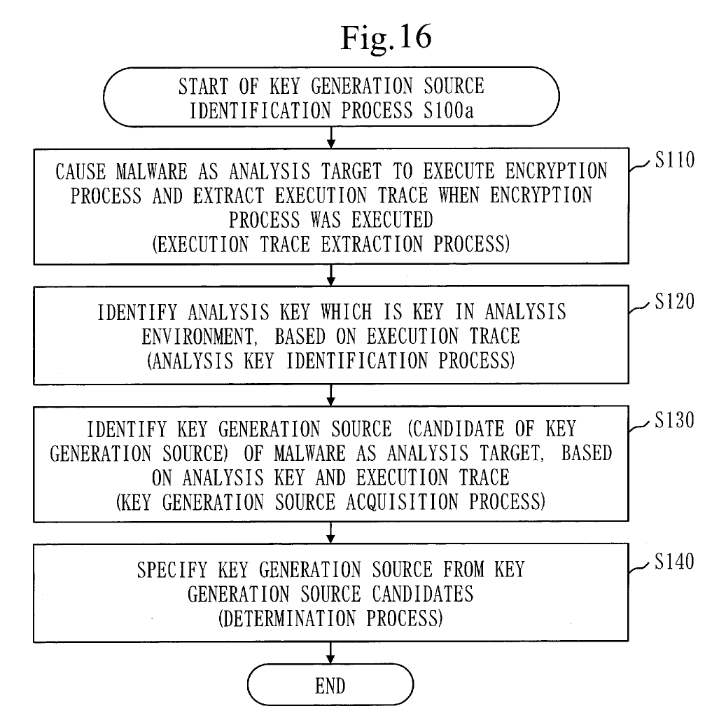

A key generation source identification process S100a of the key generation source identification device 10a according to the present embodiment will be described with reference to FIG. 16.

The key generation source identification process S100a has an execution trace extraction process S110, an analysis key identification process S120, a key generation source acquisition process S130, and a determination process S140. The execution trace extraction process S110, the analysis key identification process S120, and the key generation source acquisition process S130 are the same as the processes described in the first embodiment.

In the determination process S140, the specification unit 33 compares each of the key generation source candidates 322 with the key generation program template registered in the program database 142 and specifies a similar key generation source candidate 322 as the key generation source 321.

Here, an assemble list of a program that generates a key is registered in advance in the program database 142, as a key generation program template. The specification unit 33 compares the assemble list including each of the key generation source candidates 322 with the assemble list registered in the program database 142 and determines whether the assemble lists are similar to each other.

Here, in the comparison between the assemble lists, the Levenshtein distance of the opcode strings in the assemble lists is computed as the degree of similarity 412 and it is determined that the assemble lists are similar to each other when the distance is equal to or less than a threshold value.

The Levenshtein distance is a scale used to measure the distance between two character strings, which is also called edit distance. The number of times of addition and deletion of letters required to make character strings the same is used as the distance. Here, since the alteration is made by addition after deletion of letters, two actions are required.

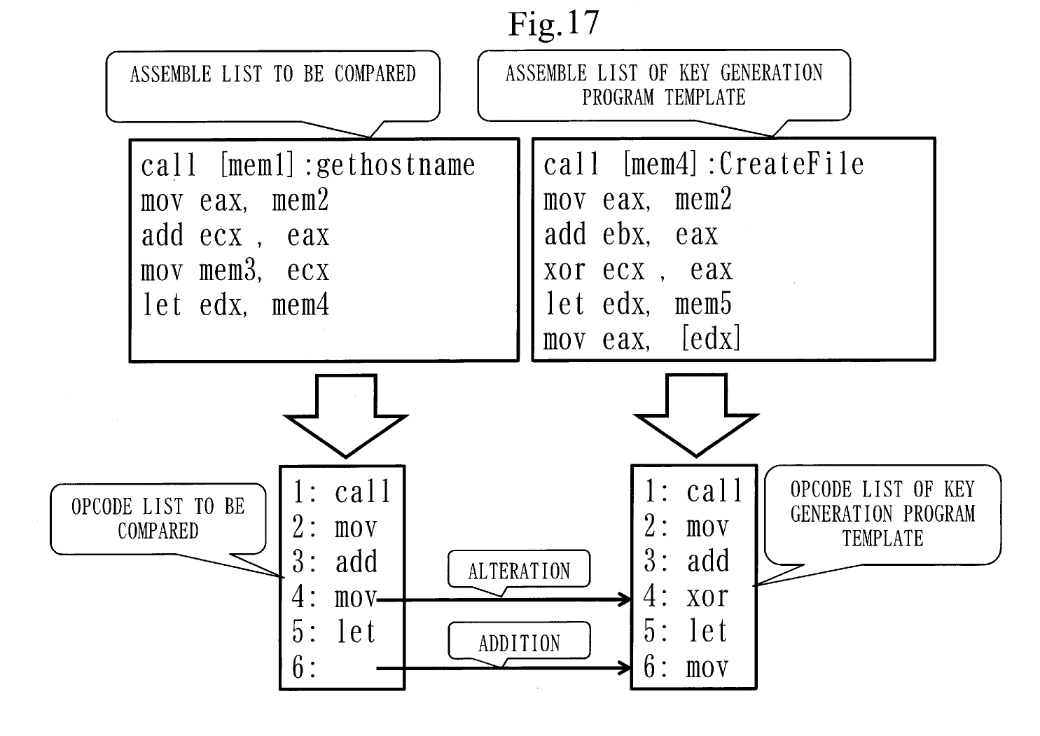

FIG. 17 exemplifies measurement of the Levenshtein distance in the present embodiment.

First, each of the assemble list to be compared, that is, the assemble list of the key generation source candidate 322, and the assemble list registered in the program database 142 is edited into a list only containing the opcodes. Comparison for the Levenshtein distance is made on these opcode lists.

Next, it is measured how many times of addition and deletion are necessary in order to make the opcode list to be compared exactly the same as the opcode list obtained from the assemble list registered in the program database 142. Here, addition and deletion are made in units of opcodes. This number of times is the distance between the two opcode lists and, when the distance is lower than the threshold value, it is determined that the assemble list being compared is the key generation source 321 or contains the key generation source 321.

In the example in FIG. 17, the opcodes in the fourth rows are different and the opcode does not exist in the sixth row. Accordingly, the distance between these two opcode lists is “3”. If this value is lower than the threshold value, it is determined that the assemble list being compared contains the key generation source 321.

There are other methods for comparing the degree of similarity, such as a method of confirming the coincidence of fuzzy hashes and a method of extracting and using the features of the key generation program by machine learning.

### Explanation of Effects According to Present Embodiment

As described thus far, the key generation source identification device 10a according to the present embodiment makes it possible to automatically obtain a key generation source which is important information for identifying the damage key from malware in a state of high precision and it becomes possible to reduce much effort to decrypt encrypted communication by malware.

### Third Embodiment

In the present embodiment, a difference from the first embodiment will be mainly described.

In the present embodiment, the same reference numerals are given to configurations similar to those described in the first embodiment and the description thereof will be omitted.

***Explanation of Configuration***

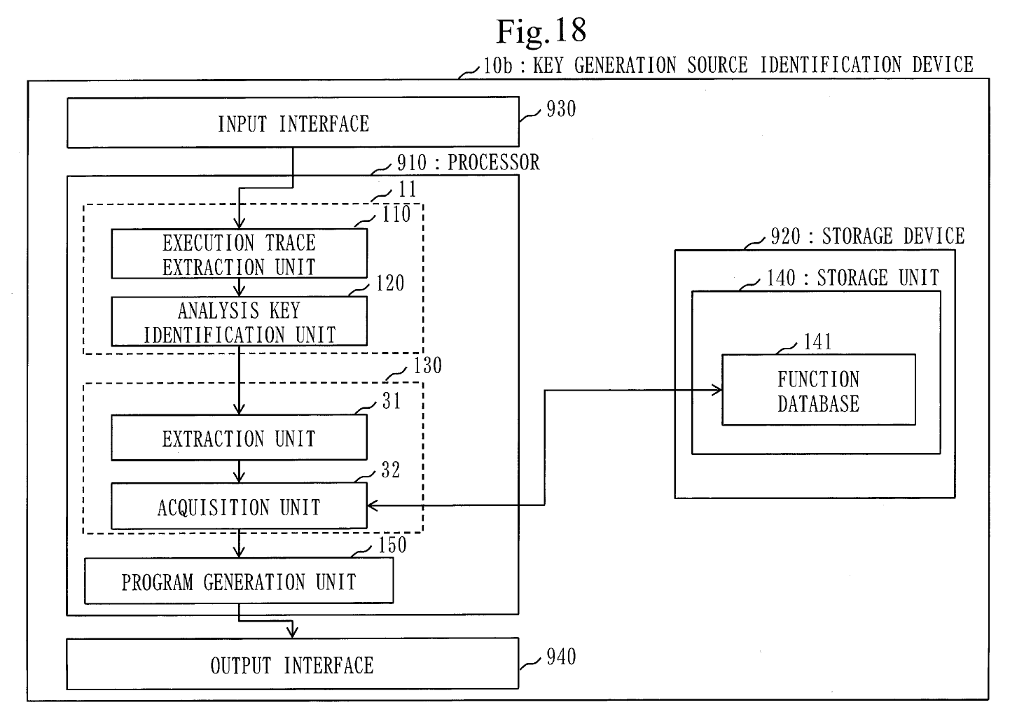

The configuration of a key generation source identification device 10b according to the present embodiment will be described with reference to FIG. 18.

In addition to the configuration of the first embodiment, the key generation source identification device 10b is provided with a program generation unit 150. The other functional configuration and hardware configuration are the same as those in the first embodiment. Therefore, in the functional configuration of the key generation source identification device 10b, the program generation unit 150 is added to the functional configuration of the key generation source identification device 10. Furthermore, in the functions of the “units” of the key generation source identification device 10b, the function of the program generation unit 150 is added to the functions of the “units” of the key generation source identification device 10. Note that the example here will indicate a mode in which the present embodiment is added to the first embodiment, but the present embodiment also can be similarly established even if the present embodiment is added to the second embodiment.

Based on a key generation source 321, the program generation unit 150 generates a key generation program 151 that generates the encryption key used in the encryption process executed in the execution environment. The key generation program 151 is a program for generating the damage key which is an encryption key in the damaged environment.

***Explanation of Operation***

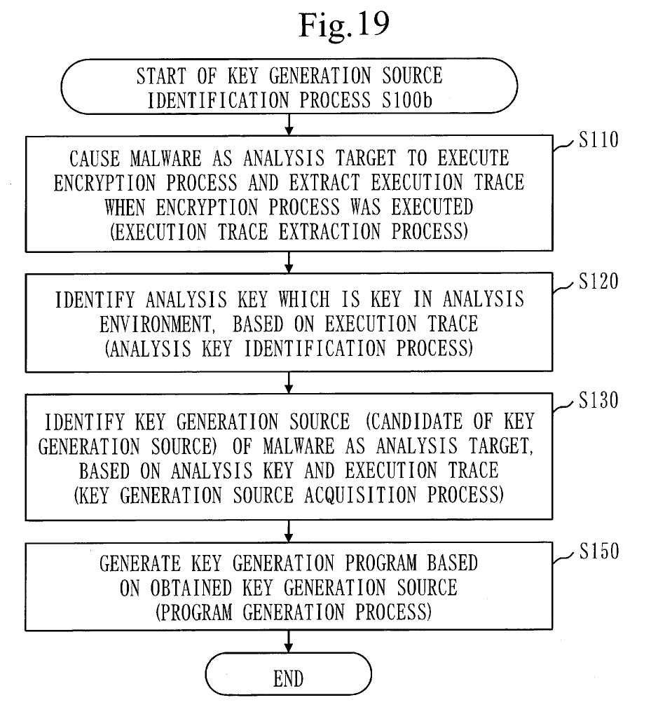

A key generation source identification process S100b of the key generation source identification device 10b according to the present embodiment will be described with reference to FIG. 19.

The generation source identification process S100b has an execution trace extraction process S110, an analysis key identification process S120, a key generation source acquisition process S130, and a program generation process S150. The execution trace extraction process S110, the analysis key identification process S120, and the key generation source acquisition process S130 are the same as the processes described in the first embodiment.

In the program generation process S150, the program generation unit 150 generates the key generation program 151 on the basis of the assemble list that leads to the analysis key 121 from the obtained key generation source 321.

The program generation process S150 is a process that utilizes the fact that the key generation program 151 is always formed by going through the assemble list recorded in the execution trace 111 as it is.

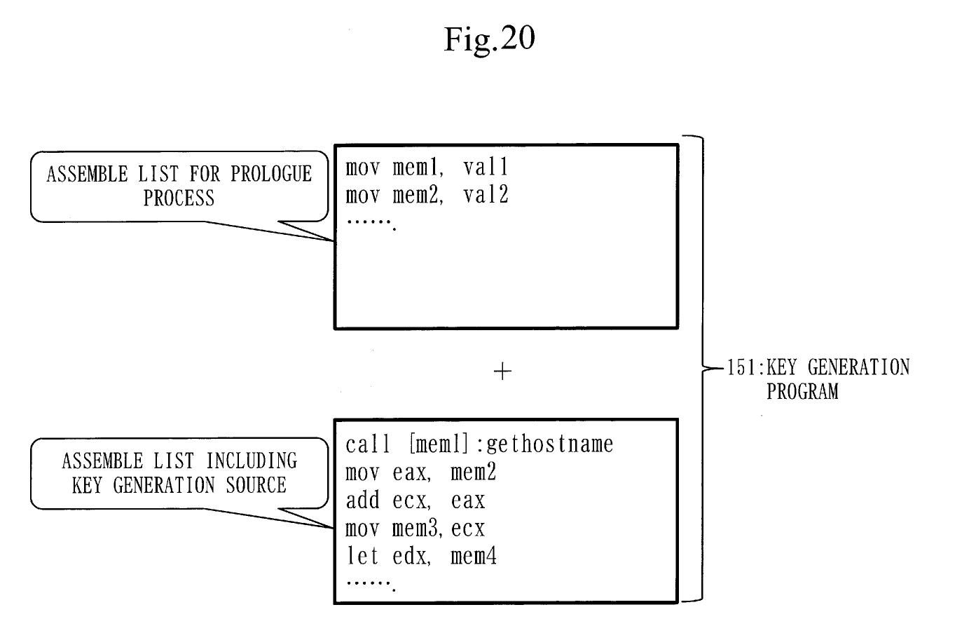

FIG. 20 is a diagram illustrating the generation of the key generation program 151 according to the present embodiment.

As illustrated in FIG. 20, the key generation program 151 is generated by appending an assemble list for a prologue process to the assemble list specified as the key generation source 321.

First, the program generation unit 150 acquires the assemble list specified as the key generation source 321. According to the assemble list specified as the key generation source 321, it is possible to obtain an algorithm of key generation by reading assemblers in the order of execution.

Furthermore, the program generation unit 150 can also set a static variable of the program by extracting a memory state at the time of program start from the execution trace 111. The program generation unit 150 generates an assemble list for performing a prologue process that sets a static variable corresponding to a memory called by the key generation source. The program generation unit 150 can create the key generation program 151 written with assemblers by creating a program such that the prologue process is performed before the assemble list specified as the key generation source 321.

### Explanation of Effects According to Present Embodiment

As described thus far, the key generation source identification device 10b according to the present embodiment can automatically obtain the key generation source and the key generation program from malware. The key generation source identification device 10b according to the present embodiment makes it possible to generate the damage key from the key generation program using environmental information in the damaged environment and it becomes possible to reduce much effort to decrypt encrypted communication by malware.

### Fourth Embodiment

In the present embodiment, a difference from the first embodiment will be mainly described.

In the present embodiment, the same reference numerals are given to configurations similar to those described in the first embodiment and the description thereof will be omitted.

***Explanation of Configuration***

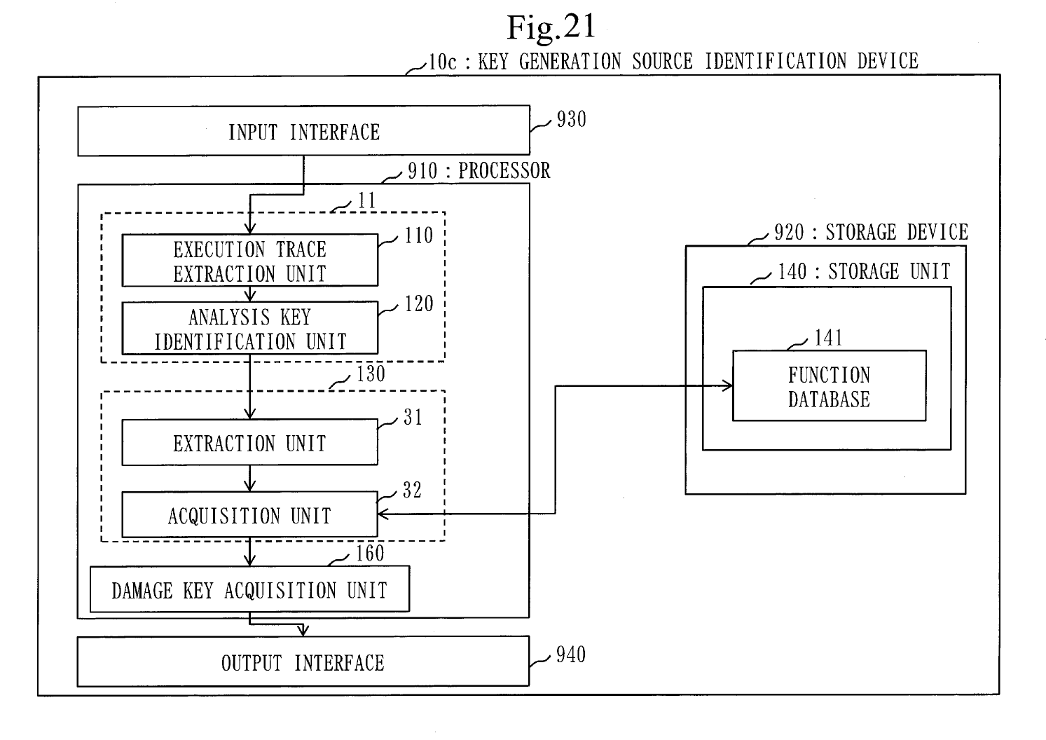

The configuration of a key generation source identification device 10c according to the present embodiment will be described with reference to FIG. 21.

In addition to the configuration of the first embodiment, the key generation source identification device 10c is provided with a damage key acquisition unit 160. The other functional configuration and hardware configuration are the same as those in the first embodiment. Therefore, in the functional configuration of the key generation source identification device 10c, the damage key acquisition unit 160 is added to the functional configuration of the key generation source identification device 10. Furthermore, in the functions of the “units” of the key generation source identification device 10c, the function of the damage key acquisition unit 160 is added to the functions of the “units” of the key generation source identification device 10. Note that the example here will indicate a mode in which the present embodiment is added to the first embodiment, but the present embodiment also can be similarly established even if the present embodiment is added to the second embodiment or the third embodiment.

The damage key acquisition unit 160 acquires the encryption key when the encryption process was executed, as a damage key 161, based on a key generation source 321, the dynamic information called by a dynamic acquisition function 411, and the execution environment. In other words, the damage key acquisition unit 160 causes malware to actually operate by adjusting the dynamic information called by the dynamic acquisition function 411 to information adapted to the execution environment of the damaged terminal infected with the malware, thereby acquiring the encryption key when the encryption process was executed in the damaged terminal, as the damage key 161.

Note that the present embodiment assumes that the damage key acquisition unit 160 receives the key generation source 321 from an acquisition unit 32.

***Explanation of Operation***

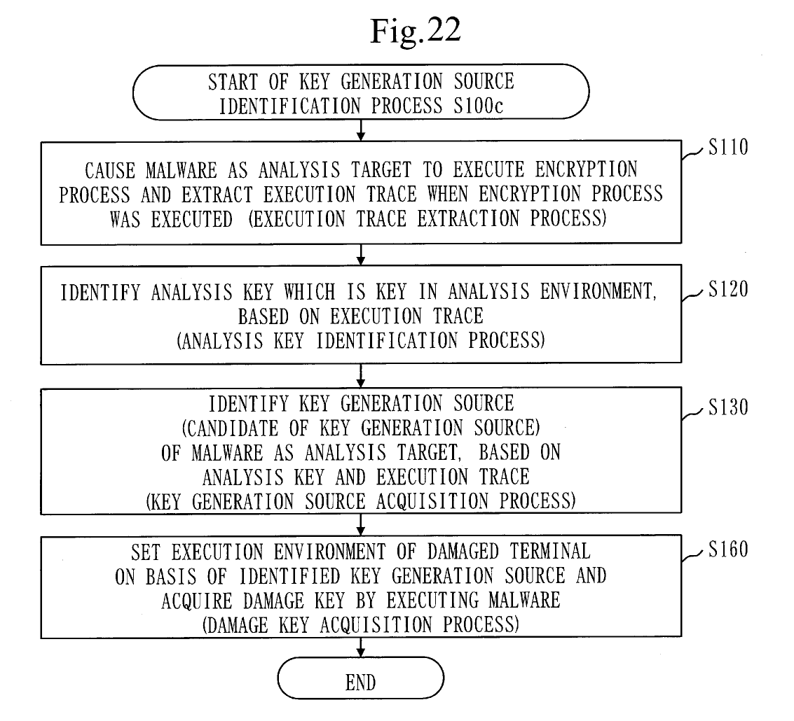

A generation source identification process S100c of the key generation source identification device 10c according to the present embodiment will be described with reference to FIG. 22.

The generation source identification process S100c has an execution trace extraction process S110, an analysis key identification process S120, a key generation source acquisition process S130, and a damage key acquisition process S160. The execution trace extraction process S110, the analysis key identification process S120, and the key generation source acquisition process S130 are the same as the processes described in the first embodiment.

In the damage key acquisition process S160, the damage key acquisition unit 160 sets environmental information indicating the execution environment of the damaged terminal on the basis of the identified key generation source 321 and extracts the damage key 161 by executing malware.

As a specific example, a description will be given of a case where the dynamic information acquired by the dynamic acquisition function 411 called by the key generation source 321 is an IP address. The damage key acquisition unit 160 extracts the IP address of the damaged environment from which the encrypted communication, that is, the encrypted file to be decrypted was acquired, from information such as a log. Next, the damage key acquisition unit 160 alters the IP address on the virtual environment where the malware is to be executed to the IP address of the damaged environment collected earlier. By causing the malware to operate in this state and extracting the key of the encryption process, the damage key acquisition unit 160 can collect the damage key 161 in the damaged environment.

### Explanation of Effects According to Present Embodiment

As described thus far, the key generation source identification device 10c according to the present embodiment can automatically obtain the damage key from malware. The key generation source identification device 10c according to the present embodiment makes it possible to automatically generate the damage key using information in the damaged environment and it becomes possible to reduce much effort to decrypt encrypted communication by malware.

While the first to fourth embodiments of the present invention have been described above, only one of those described as “units” in the description of these embodiments may be adopted, or an arbitrary combination of some of those may be adopted. In other words, the functional blocks of the key generation source identification device are arbitrary as long as the functions described in the above embodiments can be implemented. The key generation source identification device may be configured by combining these functional blocks in any way, or may be configured with arbitrary functional blocks. In addition, the key generation source identification device may be constituted by a plurality of devices instead of a single device.

Furthermore, while the first to fourth embodiments have been described, it is also possible to combine a plurality of embodiments among these embodiments to carry out. Additionally, a plurality of parts of these embodiments may be combined to be carried out. Alternatively, one part of these embodiments may be carried out. In addition, the contents of these embodiments may be combined in whole or in part in any way to be carried out.

Note that the above-described embodiments are essentially preferable examples and are not intended to restrict the scope of the present invention and its application objects and purposes. Various modifications are possible as necessary. The above-described embodiments are construed to aid in understanding of the present technique and are not construed to limit the invention.

### REFERENCE SIGNS LIST

10, 10a, 10b, 10c: key generation source identification device, 11: key identification unit, 110: execution trace extraction unit, 111: execution trace, 120: analysis key identification unit, 121: analysis key, 130: key generation source acquisition unit, 31: extraction unit, 311: instruction list, 32: acquisition unit, 33: specification unit, 321: key generation source, 322: key generation source candidate, 140: storage unit, 141: function database, 411: dynamic acquisition function, 412: degree of similarity, 142: program database, 150: program generation unit, 151: key generation program, 160: damage key acquisition unit, 161: damage key, 510: key generation source identification method, 520: key generation source identification program, 909: processing circuit, 910: processor, 920: storage device, 930: input interface, 940: output interface, S10: key identification process, S20: extraction process, S30: acquisition process, S100, S100a, S100b, S100c: key generation source identification process, S110: execution trace extraction process, S120: analysis key identification process, S130: key generation source acquisition process.

1-9. (canceled)

10. A key generation source identification device, comprising:
processing circuitry
to cause malware to execute an encryption process, acquire an execution trace representing an execution status of the encryption process, and identify an encryption key used in the encryption process as an analysis key based on the execution trace;
to extract, from the execution trace, a list of instructions on which the analysis key depends, as an instruction list; and
to determine whether a function called by a call instruction included in the instruction list is a dynamic acquisition function that acquires dynamic information dynamically changing and, when the function called by the call instruction is the dynamic acquisition function, acquire the instruction list as a candidate of a key generation source which is at least a part of a program that generated the analysis key in the encryption process.

11. The key generation source identification device according to claim 10, the processing circuitry comprising
a function database in which the dynamic acquisition function is saved, wherein
the processing circuitry determines whether the function called by the call instruction is included in the function database and, when the function called by the call instruction is included in the function database, acquires the instruction list as the candidate of the key generation source.

12. The key generation source identification device according to claim 10, the processing circuitry comprising:
a program database in which a template of a program is saved, wherein
the processing circuitry calculates a degree of similarity between the candidate of the key generation source and the template, determines whether the candidate of the key generation source is similar to the template based on the degree of similarity, and, when the candidate of the key generation source is similar to the template, specifies the candidate of the key generation source as the key generation source.

13. The key generation source identification device according to claim 10, wherein
the processing circuitry specifies the candidate of the key generation source as the key generation source.

14. The key generation source identification device according to claim 10, wherein the dynamic acquisition function acquires information dynamically changing in accordance with an execution environment of the encryption process, as the dynamic information.

15. The key generation source identification device according to claim 14, wherein
the processing circuitry generates a key generation program that generates an encryption key used in the encryption process executed in the execution environment, based on the key generation source.

16. The key generation source identification device according to claim 14, wherein
the processing circuitry acquires an encryption key when the encryption process was executed, as a damage key, based on the key generation source, the dynamic information called by the dynamic acquisition function, and the execution environment.

17. A key generation source identification method, comprising:
causing malware to execute an encryption process, acquiring an execution trace representing an execution status of the encryption process, and identifying an encryption key used in the encryption process as an analysis key based on the execution trace;
extracting a list of instructions on which the analysis key depends, from the execution trace as an instruction list; and
determining whether a function called by a call instruction included in the instruction list is a dynamic acquisition function that acquires dynamic information dynamically changing and, when the function called by the call instruction is the dynamic acquisition function, acquiring the instruction list as a candidate of a key generation source which is at least a part of a program that generated the analysis key in the encryption process.

18. A non-transitory computer readable medium storing a key generation source identification program to cause a computer to execute:
a key identification process of causing malware to execute an encryption process, acquiring an execution trace representing an execution status of the encryption process, and identifying an encryption key used in the encryption process as an analysis key based on the execution trace;
an extraction process of extracting, from the execution trace, a list of instructions on which the analysis key depends, as an instruction list; and
an acquisition process of determining whether a function called by a call instruction included in the instruction list is a dynamic acquisition function that acquires dynamic information dynamically changing and, when the function called by the call instruction is the dynamic acquisition function, acquiring the instruction list as a candidate of a key generation source which is at least a part of a program that generated the analysis key in the encryption process.
